(19) United States
(12) Patent Application Publication
(10) Pub. No.: US 2004/0143577 A1
(43) Pub. Date: Jul. 22, 2004

(54) System and method for hierarchically invoking re-entrant methods on XML objects

(75) Inventors: Sami M. Shalabi, Arlington, MA (US); Ken Hirata, Acton, MA (US); Antonio Estrada, Nashua, NH (US); Mustansir Banatwala, Hudson, NH (US)

Correspondence Address: Shelley M. Beckstrand, 314 Main Street, Owego, NY, 13827-1616, US

(73) Assignee: International Business Machines Corporation, Armonk, NY

(21) Appl. No.: 10/349,412

(22) Filed: Jan. 22, 2003

(51) Int. Cl. G06F 17/30

(52) U.S. Cl. 707/10

(57) ABSTRACT

A system and method for hierarchically invoking reentrant methods on XML objects includes a first store for storing XML objects as an input tree; a second store for storing a resultant tree; a processor for processing the input tree to generate the resultant tree; action attribute indicia representing an API to be invoked associated with at least one object; the processor executing a depth first search through the input tree for generating the resultant tree selectively including action status child nodes for XML objects having an action attribute and new script generated from processing selective action attributes; while generating the resultant tree, the processor removing the action attribute from XML action objects successfully processed; and a reentrant processing path through the processor for processing the resultant tree as a new input tree responsive to the resultant tree including said new script or failure status child nodes.

### CROSS REFERENCES TO RELATED APPLICATIONS

Copending U.S. patent applications

Ser. No. 10/334,269 filed Dec. 31, 2002 entitled “SYSTEM AND METHOD FOR THE AGGREGATION OF PLACE INFORMATION IN A MULTI-SERVER SYSTEM”;

Ser. No. 10/334,261, filed Dec. 31, 2002 entitled “SYSTEM AND METHOD FOR AGGREGATING USER PROJECT INFORMATION IN A MULTI-SERVER SYSTEM”;

Ser. No. 10/334,296, filed Dec. 31, 2002, entitled “SYSTEM AND METHOD FOR CENTRAL REFRESH OF PLACE OBJECTS”, assignee docket LOT920020061US1;

Ser. No. 10/334,268, filed Dec. 31, 2002, entitled “SYSTEM AND METHOD FOR SEARCHING A PLURALITY OF DATABASES DISTRIBUTED ACROSS A MULTI SERVER DOMAIN”, assignee docket LOT920020064US1;

Ser. No. 09/752,120, filed 29 Dec. 2000, entitled “METHOD AND SYSTEM FOR CREATING A THEME OF A PLACE TO BE USED AS A TEMPLATE FOR OTHER PLACES”;

Assignee Docket LOT920020032US1 Ser. No. 10/______, entitled “SYSTEM AND METHOD FOR COMMAND LINE ADMINISTRATION OF PROJECT SPACES USING XML OBJECTS”;

Assignee Docket LOT920020068US1 Ser. No. 10/______, entitled “SYSTEM AND METHOD FOR INTEGRATING PROJECTS EVENTS WITH PERSONAL CALENDAR AND SCHEDULING CLIENTS”;

Assignee Docket LOT920030001US1 Ser. No. 10/______, entitled “SYSTEM AND METHOD FOR INTEGRATING ONLINE MEETING MATERIALS IN A PLACE”;

are assigned to the same assignee hereof and contain subject matter related, in certain respect, to the subject matter of the present application. The above identified patent applications are incorporated herein by reference.

### TECHNICAL FIELD OF THE INVENTION

This invention relates to design of application program interfaces (APIs). More specifically, to APIs centered on an XML data model. XML representations of data objects are the mechanisms to invoke the APIs.

### BACKGROUND ART

An application programming interface (API) consists of the functions and variables that programmers are allowed to use in their applications. For example, the Java API consists of all public and protected methods of all public classes in the java.applet (classes for implementing applets), java.awt (classes for graphics, text, windows, and graphical user interfaces), java.awt.image (classes for image processing), java.awt.peer (interfaces for plateform-independent graphical user inteface toolkit), java.io (classes for input and output), java.lang (classes for the core language), java.net (classes for networking), and java.util packages (classes for useful data types).

Traditional APIs require programming knowledge, tend to be fine grained, and generally are not developed with reentrant properties. There is a need in the art for a much simpler API model.

The Extensible Markup Language (XML) is a W3C-endorsed standard for document markup. It defines a generic syntax used to mark up data with simple, human-readable tags and provides a standard format for computer documents which may be customized for domains such as web sites, electronic data interchange, and so forth. XML is a meta-markup language for text documents, and XML documents are trees. Data is included in XML documents as strings of text, and the data are surrounded by text markup that describes the text. A particular unit of data and markup is called an element. As a meta-markup language, XML does not have a fixed set of tags and elements, and elements may be defined as needed.

In XML there are several kinds of nodes, including the root node, element nodes, attribute nodes, text nodes, comment nodes, processing instruction nodes, and namespace nodes. For each type of node, there is an XSLT default built-in template rule that specifies what to do with that node if a stylesheet author has not provided more specific instructions. For example, a basic template rule copies the value of text and attribute nodes into an output document. (See Elliotte Rusty Harold & W. Scott Means. XML in a Nutshell. Sebastopol, Calif.: O'Reilly and Associates, 2001).

SOAP is a mechanism for remotely invoking instructions, or methods, through XML. However, SOAP does not use an object model as the driving representation of the methods, but has a complex XML representation that does not possess certain desirable reentrant characteristics.

Domino, IBM, the IBM Logo, Lotus, Notes, QuickPlace are trademarks of International Business Machines in the United States, other countries, or both.

### OBJECTS AND SUMMARY OF THE INVENTION

It is an object of the invention to provide an improved and simpler programmatic interface.

There is provided a method for hierarchically invoking reentrant methods on objects by associating with each object an action attribute representing an API to be invoked; processing the object to return an updated form of the object selectively including an action executed on the object; for said actions executed on the object, creating a child node with action status representing whether said action was successful; and on action success, removing the action attribute from the updated form.

There is further provided a method for hierarchically invoking reentrant methods on XML objects in a document, by traversing an XML input tree in sequential order as objects appear in the document; upon traversing in the input tree a target object with an action attribute, adding an action result object to the tree as a child object; if an error is encountered in processing the action attribute in a target object during traversal, retaining the action attribute in the target object and processing a next sibling object in sequential order without processing any children objects of the target object; and if an action attribute in a target object is successfully processed during traversal, removing the action attribute from the target object and processing a next object in sequential order.

There is further provided a system for hierarchically invoking reentrant methods on XML objects, including a first store for storing XML objects as an input tree; a second store for storing a resultant tree; a processor for processing the input tree to generate the resultant tree; action attribute indicia representing an API to be invoked associated with at least one object; the processor executing a depth first search through the input tree for generating the resultant tree selectively including action status child nodes for XML objects having an action attribute and new script generated from processing selective action attributes; while generating the resultant tree, the processor removing the action attribute from XML action objects successfully processed; and a reentrant processing path through the processor for processing the resultant tree as a new input tree responsive to the resultant tree including said new script or failure status child nodes.

In accordance with an aspect of the invention, there is provided a computer program product configured to be operable for hierarchically invoking reentrant methods on XML objects.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a system diagram illustrating an exemplary multi-server environment.

FIG. 2 is a flow chart representing generation of an output document, or resultant tree, in accordance with the preferred embodiment of the invention.

FIG. 3 is a flow chart representation of the preferred embodiment of the method of the invention.

FIG. 4 is a diagrammatic representation of an exemplary input tree shown in FIG. 2.

FIG. 5 is a diagrammatic representation of an output tree generated from the input tree of FIG. 4.

FIG. 6 is a diagrammatic representation of an output tree generated through the reentrant loop of FIG. 2.

FIG. 7 is a flow chart representation of an exemplary embodiment for building the XML API engine of FIG. 2.

FIG. 8 is a diagrammatic representation of the object model of an exemplary embodiment of the system of the invention.

### BEST MODE FOR CARRYING OUT THE INVENTION

In accordance with an exemplary embodiment of the invention, design of application program interfaces (APIs) is centered on an XML data model. XML representations of IBM® Lotus® QuickPlace® objects is the mechanism to invoke the APIs. This provides a much simpler API model, one that is driven by XML representations of the objects themselves. The XML representation defines the resultant state the programmer wishes the system to achieve. Only knowledge of XML, which is a much simpler medium to create and easily transport across systems, mediums and programs, is needed to invoke a method or group of methods.

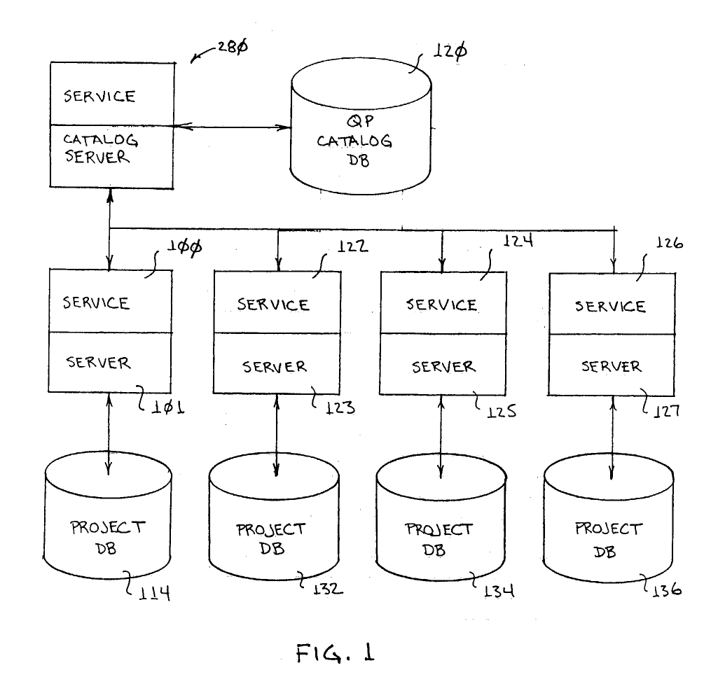

Referring to FIG. 1 catalog 120 is a database, such as a QuickPlace catalog, for aggregating information about projects, such as QuickPlaces 114, 132, 134, 136, in a multi-server system environment, including service 100/server 101, 122/123, 124/125, and 126/127.

Throughout this specification, the generic term “project” and more specific terms “place” or “QuickPlace” are used substantially interchangeably. Place and QuickPlace are examples of projects.

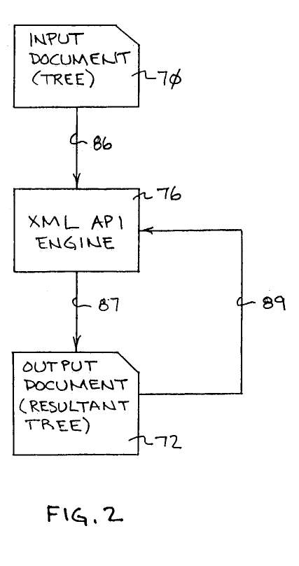

Referring to FIG. 2, XML 70 input 86 to and XML 72 output 87 from the APIs perform multiple actions in one call. Input data 86 for all APIs are the same. That is, the same object representation is used across all APIs. As is represented by line 89, input and output of an API call can be the input to another, and error and status indications are returned and maintained for each action. Reentrant path 89 provides for processing output document 72 through engine 76 if an error is found in input 86 or if new script is generated in output 87. In the later case, engine 76 is used to generate new programs 72 out of input programs 70. The methods are extensible to add support for new actions, support for multiple servers, and support for the ability to impersonate a person. Resultant tree 72 can be reinvoked, as is represented by reentrant path 89, selectively to generate new trees with or without action and, if there were errors, to rerun. During the rerun, engine 76 will start where it left off and process only those nodes that failed, and children of those nodes.

XML is created to represent, for example, a QuickPlace object. Each API capable object has an action attribute associated with it. This action attribute represents the API to be invoked. The XML 70 is passed 86 into a Java method 76, which then processes the XML and returns 87 an updated form 72 of the input XML 70. Upon completion, XML 72 similar to the input XML 70 is returned. Table 1 shows an example input document 70.

TABLE 21
EXAMPLE INPUT DOCUMENT (TREE 70)

| | |
|---|---|
| 1 | <service><servers> |
| 2 | <server local = “true” |
| 3 | <places> |
| 4 | <place action = “lock”> |
| 5 | <name>haikuteam</name> |
| 6 | </place> |
| 7 | </places> |
| 8 | </server> |
| 9 | </servers></service> |

The XML of Table 1 is used to lock the place haikuteam on the local server. After the lock API is invoked the XML of Table 2 is returned.

TABLE 22
EXAMPLE OUTPUT DOCUMENT (RESULTANT TREE 72)

| | |
|---|---|
| 1 | <service><servers> |
| 2 | <server local = “true”> |
| 3 | <places> |
| 4 | <place> |
| 5 | <name>haikuteam</name> |
| 6 | <action_result action = “create”> |
| 7 | <status>0</status> |
| 8 | </action_result> |
| 9 | </place> |
| 10 | </places> |
| 11 | </server> |
| 12 | </servers></service> |

When an action is executed on a QuickPlace object, a child node is created with the action status. This status represents if the action was successful through the returned status code in the action_result node.

To run the XML API as a person, a separate piece of XML is passed into the API. This XML identifies a given person's identity. The default person is the local server. An example of a session is provided in Table 3.

TABLE 23
EXAMPLE SESSION RUNNING XML API AS A PERSON

| | |
|---|---|
| 1 | <session> |
| 2 | <person> |
| 3 | <dn>CN=Sami Shalabi, OU=Westford, O=IBM</dn> |
| 4 | </person> |
| 5 | </session> |

If API 76 uses this session XML (Table 3), the actions are invoked using the identifier

“CN=Sami Shalabi,OU=Westford,O=IBM”.

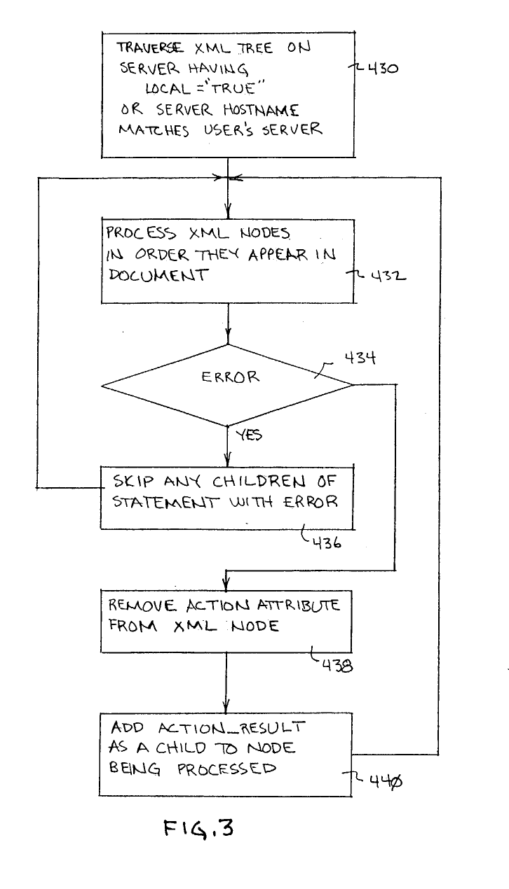

Referring to FIG. 3, the method for processing an input document 70 through the XML API engine 76 are as follows.

In step 430, XML API engine 76 runs on content 70, 114 within a server 101 that has local=“true” OR where the server hostname matches the server used by the person, for example:

<server><hostname>corn.iris.com</hostname> . . . </server>

In step 432, XML 86, 89 is processed (or, the tree is traversed) in the order it appears in the document 70, 72.

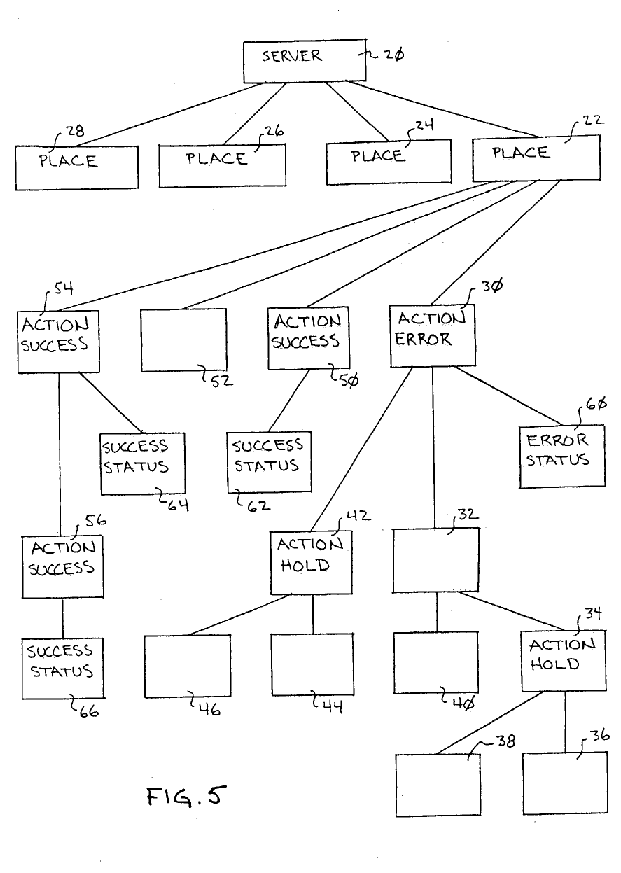

In step 436, if an error is encountered during traversal (step 434), the traversal will move to the next sibling and will not process any children. This will be more fully described hereafter in connection with FIG. 5.

In step 438, on action success (step 434), the action attribute is removed from the node being processed. On action error the action attribute will not be removed.

In step 440, when an action is processed, an action_result is always added as a child to the node being processed.

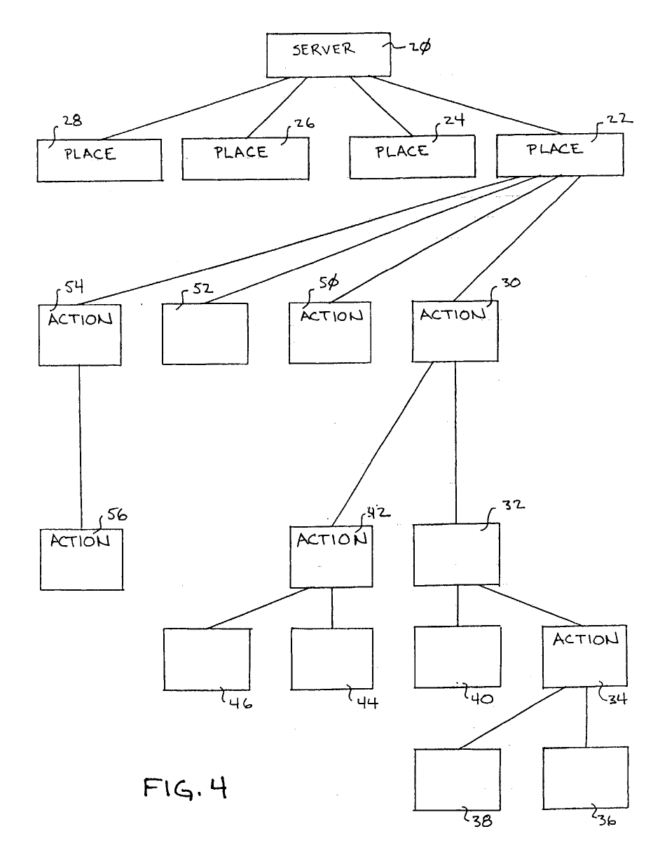

Referring to FIG. 4, an object tree is illustrated including server object 20 and place objects 22, 24, 26, 28 as children of server object 20. Place object 22 has child objects 30, 50, and 54 with actions, and child object 52 without action. Action object 56 is a child of object 54. Action object 30 a parent in the example tree including objects 32, 34, 36, 38, 40, 42, 44, and 46, as illustrated. Action objects represent methods to be invoked. A depth first search through the tree at place 22 (which is equivalent to processing XML statements in the order in which they appear in an input file) processes statements in the order 30, 32, 34, 36, 38, 40, 42, 44, 46, 50, 52, 54, and 56.

Referring to FIG. 5, a depth first search which encounters errors through the object tree of FIG. 4 beginning with place object 22 is illustrated.

First, an error is encountered in action object 30, which results in the action not being removed from object 30 and an error status object 60 being added as a child to object 30. Due to the error, children objects 32, 34, 36, 38, 40, 42, 44, and 46 are not processed, effectively placing action objects 42 and 34 on hold.

Next, action object 50 is successfully processed. When an action object is processed successfully, the action is removed from the object and a success status object 62 is added as a child of action object 50.

Next, object 52 is processed.

Next, action object 54 is successfully processed, resulting in success status object 64 being added as a child to action 54.

Finally, action object 56 is processed successfully and success status object 66 added to it as a child.

Thus, the entire tree, except for the children of nodes with errors, are processed on first pass. The errors must then be fixed by an administrator, who then restarts the process which continues from where it left off in a second pass. The second pass processes the children of nodes which were identified as having errors during the first pass without processing in this second pass nodes previously processed successfully.

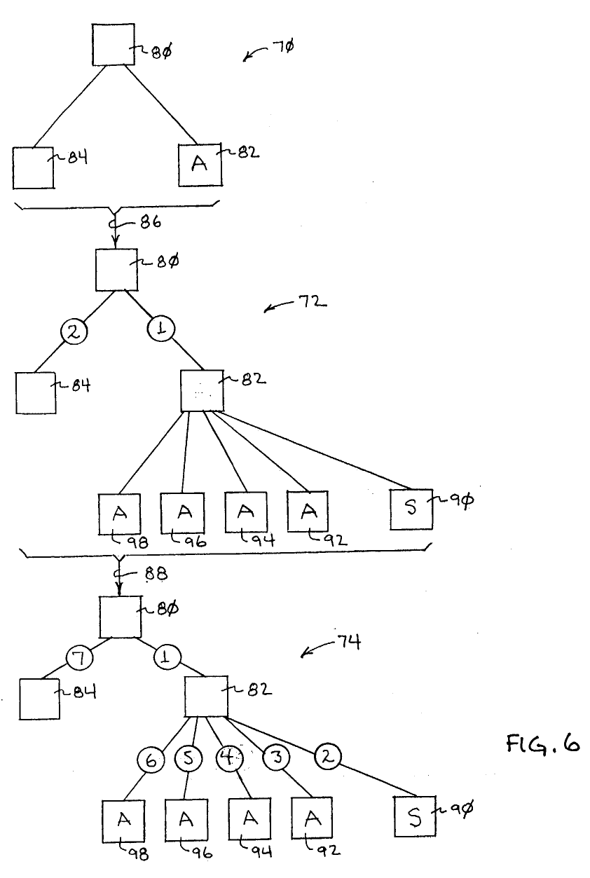

Referring to FIG. 6 in connection with FIG. 2, an example input tree 70 includes parent node 80 and child nodes 82 and 84, node 82 representing an action node. As is represented by line 86, is this is fed to XML API engine 76 which generates an output tree 72, first visiting action node 82 which results in the addition of a sub-tree including success status node 90 and action objects 92, 94, 96, and 98. Thereafter, output tree 72 is fed back, as is represented by line 89, to XML API engine 76 and processed to create a new output document (resultant tree) 74 by processing in order objects 82, 90, 92, 94, 96, 98 and 84.

In accordance with the exemplary embodiment based on a QuickPlace environment, all object representations adhere to the QuickPlace Object DTD of Table 4.

TABLE 1
DOCUMENT TYPE DEFINITION (DTD)

| | |
|---|---|
| 1 | <?xml version=“1.0” encoding=“UTF-8”?> |
| 2 | <!ELEMENT service (servers?)*> |
| 3 | <!ELEMENT servers (server*)*> |
| 4 | <!ELEMENT server (name? \| hostname? \| port? \| protocol? \| |
| 5 | path_prefix? \| placetypes? \| places?)*> |
| 6 | <!ATTLIST server |
| 7 | id ID #IMPLIED |
| 8 | local (false \| true) #IMPLIED |
| 9 | action CDATA #IMPLIED |
| 10 | > |
| 11 | <!ELEMENT placetypes (placetype*)*> |
| 12 | <!ELEMENT placetype (((name? \| description? \| |
| 13 | additional_information_url?)* \| link))> |
| 14 | <!ATTLIST placetype |
| 15 | id ID #IMPLIED |
| 16 | action CDATA #IMPLIED |
| 17 | > |
| 18 | <!ELEMENT places (place*)*> |
| 19 | <!ELEMENT place (name? \| placetype? \| title? \| members? \| |
| 20 | rooms? \| archive_directory? \| lock_message? \| last_accessed? \| |
| 21 | last_modified? \| size? \| meta_data?)*> |
| 22 | <!ATTLIST place |
| 23 | id ID #IMPLIED |
| 24 | locked (false \| true) #IMPLIED |
| 25 | action CDATA #IMPLIED |
| 26 | > |
| 27 | <!ELEMENT person (((dn?)* \| (username? \| password? \| email? \| |
| 28 | first_name? \| last_name?)*) \| description? \| |
| 29 | offline_password? \| theme?)*> |
| 30 | <!ATTLIST person |
| 31 | id ID #IMPLIED |
| 32 | local (false \| true) #IMPLIED |
| 33 | action CDATA #IMPLIED |
| 34 | subscribed_to_newsletter (true \| false) #IMPLIED |
| 35 | using_accessible_ui (false \| true) #IMPLIED |
| 36 | subscribed_to_calendar_events (true \| false) #IMPLIED |
| 37 | email_client (notes5 \| notes6 \| outlook \| ical \| other) |
| 38 | #IMPLIED |
| 39 | > |
| 40 | <!ELEMENT group (((dn?)* \| (username?)* \| username?) \| |
| 41 | description?)*> |
| 42 | <!ATTLIST group |
| 43 | id ID #IMPLIED |
| 44 | local (false \| true) #IMPLIED |
| 45 | action CDATA #IMPLIED |
| 46 | > |
| 47 | <!ELEMENT rooms (room*)*> |
| 48 | <!ELEMENT room (name? \| access?)*> |
| 49 | <!ATTLIST room |
| 50 | id ID #IMPLIED |
| 51 | action CDATA #IMPLIED |
| 52 | > |
| 53 | <!ELEMENT access (managers? \| authors? \| readers?)*> |
| 54 | <!ELEMENT managers (member*)*> |
| 55 | <!ELEMENT readers (member*)*> |
| 56 | <!ELEMENT authors (member*)*> |
| 57 | <!ELEMENT members (person* \| group*)*> |
| 58 | <!ELEMENT member (link?)*> |
| 59 | <!ATTLIST member |
| 60 | action CDATA #IMPLIED |
| 61 | > |
| 62 | <!ELEMENT meta_data ANY> |
| 63 | <!ATTLIST meta_data |
| 64 | action CDATA #IMPLIED |
| 65 | > |
| 66 | <!ATTLIST link |
| 67 | idref IDREF #REQUIRED |
| 68 | > |
| 69 | <!ELEMENT protocol (#PCDATA)> |
| 70 | <!ELEMENT path_prefix (#PCDATA)> |
| 71 | <!ELEMENT port (#PCDATA)> |
| 72 | <!ELEMENT hostname (#PCDATA)> |
| 73 | <!ELEMENT name (#PCDATA)> |
| 74 | <!ELEMENT password (#PCDATA)> |
| 75 | <!ELEMENT archive_directory (#PCDATA)> |
| 76 | <!ELEMENT offline_password (#PCDATA)> |
| 77 | <!ELEMENT title (#PCDATA)> |
| 78 | <!ELEMENT theme (#PCDATA)> |
| 79 | <!ELEMENT username (#PCDATA)> |
| 80 | <!ELEMENT description (#PCDATA)> |
| 81 | <!ELEMENT additional_information_url (#PCDATA)> |
| 82 | <!ELEMENT dn (#PCDATA)> |
| 83 | <!ELEMENT email (#PCDATA)> |
| 84 | <!ELEMENT size (#PCDATA)> |
| 85 | <!ELEMENT lock_message (#PCDATA)> |
| 86 | <!ELEMENT first_name (#PCDATA)> |
| 87 | <!ELEMENT last_name (#PCDATA)> |
| 88 | <!ELEMENT last_accessed (#PCDATA)> |
| 89 | <!ELEMENT last_modified (#PCDATA)> |
| 90 | <!ELEMENT link EMPTY> |

In the DTD of Table 1,

UTF-8 is the character set

| represents logical “OR”

? permits zero or one of the element

<!> are the comment delimiters

* permits zero or more of the element

+ permits one or more of the element

#implied means optional

#required means required

dn is the a distinguished name

ui is a user interface

id is an identifier which is unique in the entire file

#PCDATA element may contain only parsed character data, and may not contain child elements of any type

CDATA element can contain any string of text acceptable in a well-formed XML attribute value

### XML API Engine

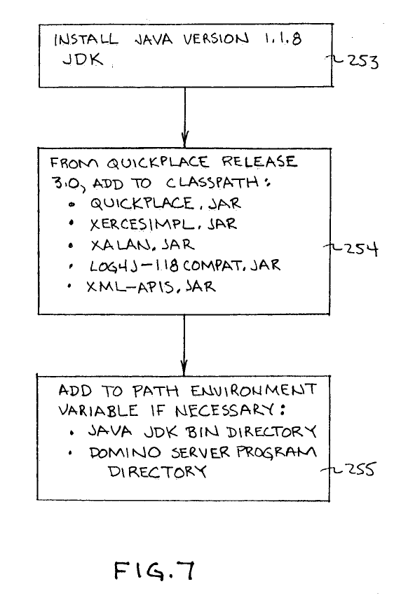

Referring to FIG. 7, in accordance with an exemplary embodiment of the invention based on the QuickPlace environment, XML API engine 76 is built as follows.

In step 253, JAVA version 1.1.8 JDK is installed on your server 101. JAVA 1.1.8 JDK can be downloaded from the Sun Microsystems™ web site.

In step 254, the following files proved by QuickPlace Release 3 are added to the CLASSPATH:

quickplace.jar

xercesimpl.jar

xalan.jar

log4j-118compat.jar

xml-apis.jar

In step 255, the following is added to the PATH environment variable if necessary.

JAVA JDK bin directory

Domino Server program directory

Server 101 is now set up to run a QuickPlace JAVA XML script 76. In this exemplary embodiment, although the use of the JAVA XML API 76 does not require that the user write a JAVA program to run the XML scripts, the interface for executing the scripts is written in JAVA, which is why the JAVA JDK and runtime environment are required on server 101 on your machine.

In this exemplary embodiment, the entry point used to execute XML script on XML API engine 76 is:

QPAPI.process( )

The process( ) method is responsible for parsing and processing XML document 70 and executing the supported QuickPlace API actions it encounters. There are several variations of the process( ) method that can be used, as follows:

1. process( String inFilename, String sessionFilename, String outFilename)

This entry point is called by QPAPI.main( ), and is the entry point that is called to execute the QPAPI JAVA class with arguments. The parameters have the following meanings:

inFilename The pathname of the XML document 70 to be processed by the QuickPlace JAVA XML API 76.

sessionFilename Used when executing XML search API actions.

outFilename The pathname of a file 72 to be created by QuickPlace JAVA XML API 76 that will contained the processed output XML. This document 72 will be very similar to the input document 70 but will be modified by the QuickPlace API 76 to show action status codes and output results of the specific actions if applicable.

2. process( String inFilename)

When this method is used processing results and error statuses are formatted in the output file, and the user is not otherwise notified of their occurrence. The parameters have the following meanings:

inFilename The pathname of the XML document 70 to be processed by the QuickPlace JAVA XML API 76.

3. process( String inFilename, String outFilename)

This entry point is used when the user supplies XML input file 70 and all processed output 87 is to be captured in an XML output file 72 created by QuickPlace. The parameters have the following meanings:

inFilename The pathname of the XML document 70 to be processed by the QuickPlace JAVA XML API 76.

outFilename The pathname of a file 72 to be created by the QuickPlace JAVA XML API 76 that will contain the processed output XML 87. This document 72 will be very similar to the input document 70 but will be modified by the QuickPlace API 76 to show action status codes and output results of the specific actions if applicable.

4. process( Node session, Node root)

This entry point is used when the user has an XML DOM tree schema. It is primarily used in JAVA programs that build the XML structure on the fly. The parameters have the following meanings:

session The session Node. Normally, the session of the server 101 is used when processing the XML document 70, and is required when executing the XML search API actions.

root The root node of the XML DOM tree schema object. The root node is usually obtained from an XML parser in a JAVA application.

5. process (Node root)

This entry point is used when you the user has an XML DOM tree schema. It is primarily used in JAVA programs that build the XML structure on the fly. The parameters have the following meanings:

root The root node of the XML DOM tree schema object. The root node is usually obtained from an XML parser in a JAVA application.

### Running the QPAPI Executable JAVA Class

The QPAPI class may be used to process QuickPlace XML documents without writing JAVA code. This class accepts an XML document 70 as input. Below is the syntax for executing an XML script against the QPAPI class:

java com.lotus.quickplace.api.QPAPI -i myXMLScript.xml

The above is processed by a JAVA interpreter and the QPAPI.process( ) method is invoked to process the script. This requires that the JAVA runtime environment be installed on the users machine because it is responsible for executing the QPAPI class. Additionally, the QPAPI class may be executed with the following arguments:

-i inputfile.xml where inputfile.xml represents the name of the XML document 70 to be processed.

-o outputfile.xml where outputfile.xml represents the name of the XML output document 72 created by QuickPlace which contains all of the processed output and status codes.

-session file.xml where file.xml represents the name of the session XML file that is used by QuickPlace to manage the user's session.

### Executing QuickPlace XML From Within a JAVA Application

XML can also be generated programmatically and processed through the QPAPI.process( ). Table 5 is a sample JAVA code fragment illustrating the necessary pieces needed to process the XML document.

TABLE 5
SAMPLE JAVA CODE FOR PROCESSING XML DOCUMENT

| | |
|---|---|
| 1 | import com.lotus.quickplace.api.QPAPI; |
| 2 | class TestQPIAPI |
| 3 | { |
| 4 | static void run( ) |
| 5 | { |
| 6 | // this is called once for the process at |
| 7 | startup |
| 8 | QPAPI.init( ); |
| 9 | // build and get XML DOM tree schema for session |
| 10 | and XML action script. |
| 11 | // The programmer provides the functionality to |
| 12 | build the XML properly in the methods below |
| 13 | Node sessionXML = buildQPSessionXML( ); |
| 14 | Node root = buildQPXML( ); |
| 15 | // call this entry point to process using the |
| 16 | server session |
| 17 | QPAPI.process( root); |
| 18 | // call this entry point to process using a user |
| 19 | session (only used when doing search places) |
| 20 | // all other actions ignore the session. |
| 21 | QPAPI.process( sessionXML, root); |
| 22 | // this is called once for the process at |
| 23 | shutdown |
| 24 | |
| 25 | QPAPI.term( ); |
| 26 | } |
| 27 | } |

In summary, the following components are used to execute XML from within a JAVA program: ps 1. The QPAPI.init( ) method is called prior to any other QuickPlace processing.

2. The programmer supplies functionality to properly construct the XML document based upon the needs of the application

3. The QPAPI.process( Node root) or other QPAPI.process( ) method (described earlier) is called to initiate the processing of the generated XML document. This method will process the entire document and perform all QuickPlace actions defined within it.

4. The QPAPI.term( ) method is called to terminate the QuickPlace processing and free up resources.

### Object Model

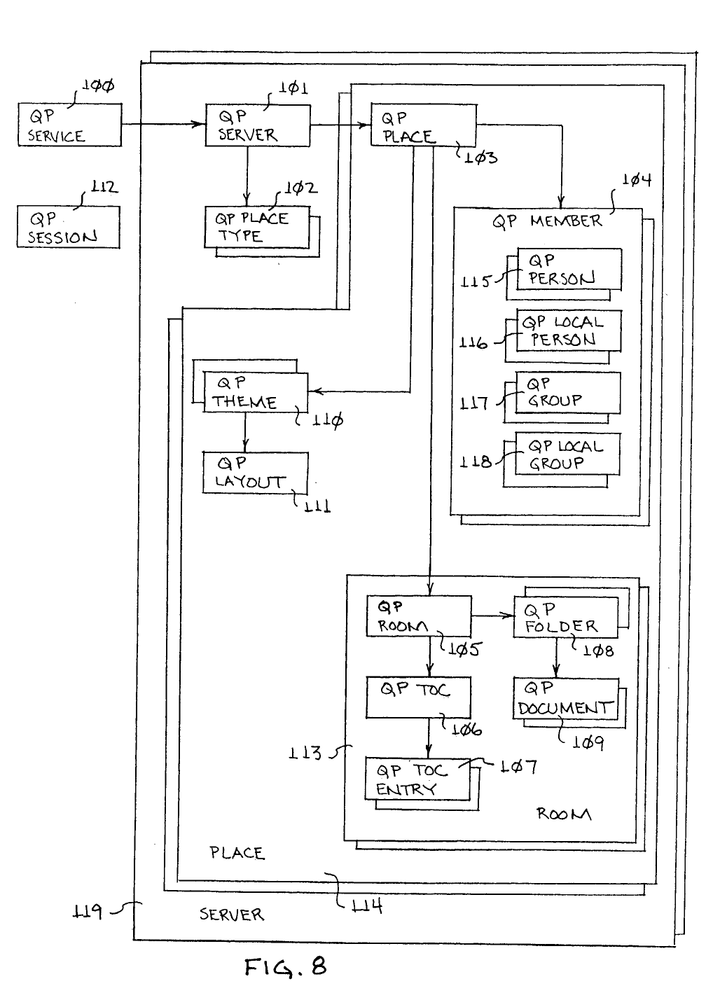

Referring to FIG. 8, a high level object model representation of an exemplary embodiment of the invention is presented. Each box represents a unit that can be manipulated and used to retrieve and store data. Each object has several associated methods.

QP service 100 represents the service. A service is an object that signifies a group of servers in an organization. There is one instance of a service 100 for any group of servers. Thus, a QuickPlace service is a multi-server deployment of QuickPlace servers that can be treated as a consistent unit of service for administration and in the user interface.

A QuickPlace service comprises multiple QuickPlace servers and/or QuickPlace clusters, which: (1) are in the same IBM® Lotus® Domino™ domain; (2) share the same user directory and authentication system; (3) are on the same user network (i.e., are not separated by a firewall); and (4) are administered by the same administration team.

These constraints are enough to ensure across the service that: (1) servers can be configured consistently; (2) servers can communicate and share data with each other; (3) user identities are in the same name space and do not collide; and (4) single sign on authentication can be implemented.

A QuickPlace cluster is treated as a single virtual server in the service model.

Server 101 represents a physical or virtual server entity that is addressable and may contain a group of places and place types.

Place 103 is an object that represents a place or project. This is the entry point into a particular project and all its data and all its manipulations—including logical methods such as lock, remove, member, and so forth.

QP members 104 represents members of place 114. There are many kinds of members, including person 115, local person 116, group 117 and local group 118. Members 104 are the seed of any membership operation done in the place 103. Each member has an associated identity and profile.

Room 105 represents a room 113 within a project 114.

In an exemplary embodiment, a project is a place, which is content and membership associated with that content.

A room 105 controls access to a subset of the data in the project 114, including table of contents (TOC) 106, and folders 108.

TOC 106 represents the table of contents of a room 113, which is composed of many TOC entries 107, which TOC entry includes a url to a content and the associated type (folder, room, document, etc.) of that content.

Folder 108 contains many documents 109, and each room 113 can contain many folders 108.

Documents 109 represent documents in a place 114.

Each place 114 may contain many themes 110. A theme is an object that represents how to lay out the user interface for this project, and how to brand the user interface.

Layout 111 specifies one of the ways a theme 110 is laid out. Associated with each theme 110 there may be several layouts.

Session 112 is a session needed to work with this object model. It provides for associating an identity with any manipulation. For example, if when creating a place 114 on a server 119, session 112 represents the identity of the individual. If that individual does not have authorization to create a place 114, an error will be received.

Rooms 113 represent multiple rooms in a place 114.

Places 114 represents multiple places on a server 119.

Each object is able to represent itself as xml and recreate itself from the exported xml.

### Service Object 100

Service object, or node, 100 represents a container for one or more servers 119 that comprise the QuickPlace service. Servers that are part of a service can be manipulated with the following actions:

query

getPlaces

getServers

search

<Query> queries QuickPlace service 100 for specific data. By providing a query capability at the service level, the administrator is able to retrieve specific information from one or more QuickPlaces 114 that are part of the service 100. Table 6 gives the syntax for the query action.

TABLE 3
QUERY ACTION SYNTAX

| | |
|---|---|
| 1 | Syntax 1: |
| 2 | <service action=“query”> |
| 3 | <query type=“get_member_places”> |
| 4 | <members> |
| 5 | <person> |
| 6 | . . . |
| 7 | </person> |
| 8 | </members> |
| 9 | </query> |
| 10 | </service> |
| 11 | Syntax 2: |
| 12 | <service action=“query”> |
| 13 | <query type=“ft_search”> |
| 14 | <query_string>properly formatted full-text |
| 15 | query</ query_string > |
| 16 | </query> |
| 17 | </service> |

The <query> action node supports the following attributes:

Attribute Name: type

Supported Values:

“get_member_places”

Specifies whether or not the server is local to the executing XML script. For the specific example embodiment based on QuickPlace 3.0, all servers specified in the XML document are considered to be local to the executing script so it is not necessary to specify this attribute.

get_member_places

Given a member name, retrieves all places of the service that the specified name is a member of. Member places are listed by server name and server names are listed by service which is essentially all servers listed in the place catalog.

ft_search

Given a query string, retrieves all places in the Place Catalog that satisfy the conditions specified in the query

For each of the above query types, the results of the query are returned in the format of Table 7.

TABLE 7
QUERY RESULTS SYNTAX

```
<servers>
    <server>
        <place>
        </place>
    </server>
</servers>
```

The getPlaces action retrieves all places listed in the place catalog. Table 8 gives the syntax for the getplaces action. Places are listed by server name. The results of the query are returned in the format of Table 7.

TABLE 5
GETPLACES ACTION SYNTAX

<service action=”getPlaces”>
</service>

The getServers action retrieves all QuickPlace servers listed in the place catalog. Places are listed by server name. The syntax for this action is:

Syntax: <service action=“getServers”>

The results of the getServers query are returned in the format of Table 9.

TABLE 6
GETSERVERS QUERY RESULTS SYNTAX

| | |
|---|---|
| 1 | <servers> |
| 2 | <server> |
| 3 | </server> |
| 4 | </servers> |

The search action performs a “full-text” search across all QuickPlaces in the QuickPlace service. It returns an error action status if the QuickPlace configuration specifies that Search Places is disabled or if Search Places for Anonymous Users is disabled and the identity performing the search is anonymous. Table 10 sets forth the syntax and required XML for the search action.

TABLE 7
SEARCH ACTION SYNTAX AND REQUIRED XML

| | |
|---|---|
| 1 | Syntax: |
| 2 | <service action=”search” order=”1 \| 2 \| 3” start=”n” |
| 3 | count=”n”> |
| 4 | <query> |
| 5 | “Properly formatted full-text query string” |
| 6 | </query> |
| 7 | Required: |
| 8 | <service action=“search”> |
| 9 | <query order=“1 \| 2 \| 3”> |
| 10 | “Properly formatted full-text query string” |
| 11 | </query> |
| 12 | </service> |

The criteria for the search are specified by the following attributes:

Attribute Name: type

Supported Values:

order A numeric value that specifies the search return sort order. The following values are supported:

1 Return results sorted by relevance

2 Return results sorted with oldest occurrences first

3 Return results sorted with newest occurrences first

start Specifies the starting position of the search results to be returned. A value of zero is used if this attribute is not specified. A starting position of zero specifies that results starting with the first match should be returned.

count Specifies the maximum number of search match hits to be returned. A value of 15 is used if this attribute is not specified. A count of −1 specifies that the maximum number of hits should be returned.

### Server Object 101

Server node 101 represents an installed QuickPlace server in the QuickPlace service 100. All actions performed on a QuickPlace server are executed from within the server node hierarchy. In the QuickPlace 3.0 release embodiment actions on performed only on the local server where the XML script 76 is executing. To perform actions on other servers in the service, the XML script is executed on each of the other servers. The server node supports the following actions:

getPlaceTypes

getPlaces

refreshPlaces

forceRefreshPlaces

upgradeAllPlacesAndPlaceTypes

forceUpgradeAllPlacesAndPlaceTypes

upgrade

forceupgrade

### Server Node Attributes

The server node supports the following attribute:

Attribute Name: local

Syntax: <server local=“true”></server>

Supported Values: “true”|“false”

Specifies whether or not the server is local to the executing XML script. For the QuickPlace 3.0 release, all servers specified in the XML document are considered to be local to the executing script so it is not necessary to specify this attribute. This may change in a future release.

### Server Node Named Elements

The server node supports the following named elements:

<name>

<hostname>

<port>

<url_prefix>

The <name> element is used by the server node to specify the name of the server. The full canonical name or the abbreviated name of the Domino Server that this script is executing against may be specified. The name used is the name of the local Domino Server in which this script executes against. Syntax of the <name> element is set forth in Table 11. The <name> element is required if <local=“true”> attribute is not specified or equals “false”.

TABLE 8
SYNTAX OF NAME ELEMENT

| | |
|---|---|
| 1 | <server> |
| 2 | <name>QPServer/ACME</name> |
| 3 | </server> |

The <hostname> element is used by the server node to specify the host name that the script executes against. The name used should be an IP address or DNS resolvable host name. Syntax of the <hostname> element is set forth in Table 12. The <hostname> element is required if the <local=“true”> attribute is not specified or equals “false”.

TABLE 12
SYNTAX OF HOSTNAME ELEMENT

<server>
<hostname>qpserver.acme.com</hostname>
</server>

The <port> element, which is optional, is used by the server node to specify the listening port of the server against which the script is executing. The syntax of the <port> element is set forth in Table 13.

TABLE 13
SYNTAX OF THE PORT ELEMENT

<server>
<port>80</port>
</server>

The optional <curl_prefix> element is used by the server node to specify the URL prefix to the hostname of the server executing the script. Its syntax is set forth in Table 14.

TABLE 14
URL_PREFIX ELEMENT SYNTAX

<server>
<url_prefix>http://</url_prefix>
</server>

### Server Node Actions

The <server> node supports the following named actions:

getPlacesTypes

getPlaces

forceRefreshPlaces

refreshplaces

forceUpgradeAllPlacesAndPlaceTypes

upgradeAllPlacesAndPlaceTypes

forceupgrade

upgrade

getPlaceTypes retrieves all placetypes that exist on the specified server. The “standard” QP PlaceType is h_StdPlaceType. Placetypes are listed by server name. The syntax for getPlaceTypes is:

<server action=“getPlaceTypes”>

</server>

The results of the action are returned in the format of Table 15.

TABLE 15
GETPLACETYPES RESULTS FORMAT

```
<server>
      <placetypes>
            <placetype>
                  <placetype id=“8912471890219238”>
                  <name>ACMETeamPlacetype</name>
                  <description>The ACME Team's
                  Placetype</description>
                  <additional_information_url>
                        http://www.acme.com/acmeteaminfo
                  </additional_information_url>
            </placetype>
            . . .
      </placetypes>
</server>
```

getPlaces retrieves all places that exist on the specified server. Places are listed by server name.

forceRefreshPlaces refreshes all places on the specified server from their respective placetypes. The refresh action occurs immediately. No action is performed if a place does not adhere to a placetype.

refreshPlaces refreshes all places on the specified server from their respective placetypes. The refresh action occurs at the next scheduled interval when the QuickPlace nightly maintenance process is run on the server. No action is performed if a place does not adhere to a placetype.

forceUpgradeAllPlacesAndPlaceTypes upgrades all places and placetypes on the specified server from a previous QuickPlace release. This action occurs immediately. The upgrade process involves refreshing the design of QuickPlace system files as well as the schema and design of user QuickPlaces. This action will forcibly invoke the upgrade process even if the places and placetypes on the server have already been upgraded.

upgradeAllPlacesAndPlaceTypes upgrades all places and placetypes on the specified server from a previous QuickPlace release. This action occurs immediately. If the server has already been upgraded then this action will have no effect. The upgrade process involves refreshing the design of QuickPlace system files as well as the schema and design of user QuickPlaces. This action will no effect if the places and placetypes on the server have already been upgraded.

forceupgrade upgrades the specified QuickPlace server from a previous release. This action occurs immediately. All core QuickPlace files are upgraded as well as the admin place if installed on the server. This action will forcibly invoke the upgrade process even if the server has already been upgraded.

upgrade upgrades the specified QuickPlace server from a previous release. This action occurs immediately. All core QuickPlace files are upgraded as well as the admin place if installed on the server. If the server has already been upgraded then this action will have no effect.

### Place Object 103

Place node 103 represents a QuickPlace on the QuickPlace server 101 in the QuickPlace service 100. All actions performed on a place are executed from within the server node hierarchy.

The place node supports the following named elements:

<name>

<placetype>

The <name> element is required for all supported place actions (create, remove, etc.) It is used by the place node to specify the name of the place being serviced. This name refers to a place on the local server executing the script.

The <placetype> element is used by the place node to specify the placetype that is associated with the place being serviced. The placetype element is primarily used when creating and refreshing places. When performing operations involving a placetype, the user must previously define the place and assign it an idref id with the <link> element. The placetype is then referenced by the idref value later on in the script.

Place node 103 supports the following actions:

create

remove

forceRemove

update

lock

unlock

repair

refresh

forceRefresh

archive

registerInPlaceCatalog

unregisterInPlaceCatalog

register

unregister

changeHierarchy

sendDailyNewsLetter

sendWeeklyNewsLetter

sendMailToMembers

sendMailToManagersonly

upgrade

forceupgrade

### PlaceType Object 102

PlaceType node 102 represents a QuickPlace placetype on the QuickPlace server 101 in the QuickPlace service 100. All actions performed on a placetype are executed from within the server node hierarchy.

The placetype node supports the following named element:

<name>

which is required for all supported placetype actions. The <name> element is used by the <placetype> node to specify the name of the placetype being serviced. This name refers to a placetype on the local server executing the script.

Placetype supports the following actions:

refresh

forceRefresh

refreshChildPlaces

forceRefreshChildPlaces

upgrade

forceupgrade

remove

forceRemove

The refresh action refreshes the placetype specified by <name> on the server specified by <server>. If the placetype has already been refreshed then the operation will not occur.

TABLE 16
REFRESH ACTION EXAMPLE

```
<service><servers>
      <server local=“true”>
            <placetype action=“refresh”>
                  <name>AcmeTeamPlaceType</name>
            </placetype>
      </server>
</servers></service>
```

The forceRefresh action refreshes the placetype specified by <name> on the server specified by <server>. If the placetype has already been refreshed then this action will force a refresh of the placetype. Table 17 provides an example.

TABLE 17
FORCEREFRESH ACTION EXAMPLE

```
<service><servers>
      <server local=“true”>
            <placetype action=“forceRefresh”>
                  <name>AcmeTeamPlaceType</name>
            </placetype>
      </server>
</servers></service>
```

The refreshChildPlaces action refreshes the all derived children of the placetype specified by <name> on the server specified by <server>. If the child placetypes have already been refreshed then the operation will not occur. Table 18 is an example.

TABLE 18
REFRESHCHILDPLACES ACTION EXAMPLE

```
<service><servers>
      <server local=“true”>
            <placetype action=“refreshChildPlaces”>
                  <name>AcmeTeamPlaceType</name>
            </placetype>
      </server>
</servers></service>
```

The forceRefreshChildPlaces action refreshes the all derived children of the placetype specified by <name> on the server specified by <server>. If the child placetypes have already been refreshed then refresh will occur regardless. Table 19 is an example.

TABLE 19
FORCEREFRESHCHILDPLACES ACTION EXAMPLE

```
<service><servers>
      <server local=“true”>
            <placetype action=“forceRefreshChildPlaces”>
                  <name>AcmeTeamPlaceType</name>
            </placetype>
      </server>
</servers></service>
```

The remove action removes the specified placetype from the specified server. Removal of the placetype is performed when the QuickPlace Nightly maintenance process runs on the server. Table 20 is an example.

TABLE 20
REMOVE ACTION EXAMPLE

```
<service><servers>
    <server local=“true”>
        <placetype action=“remove”>
            <name>AcmeTeamPlaceType</name>
        </placetype>
    </server>
</servers></service>
```

The forceRemove action removes the specified placetype from the specified server. Removal of the placetype is performed immediately.

The upgrade action upgrades the specified placetype on the specified server from a previous version of QuickPlace. This action occurs immediately. The specified placetype is locked during the upgrade process. If the specified placetype has already been upgraded then this action will have no effect.

The forceUpgrade action upgrades the specified placetype on the specified server from a previous version of QuickPlace. This action occurs immediately. The specified placetype is locked during the upgrade process. If the specified placetype has already been upgraded then this action will force another upgrade of the placetype regardless.

### Person Object 115

Person node 115 represents a person on the QuickPlace server 101 in the QuickPlace service 100.

The <person> node 115 supports the following attributes:

local

subscribed_to_newsletter

subscribed_to_calendar_events

using_accessible_ui

email_client

The local attribute specifies whether or not the person is local to the specified place XML script. A value of “true” indicates that the person exists only in the specified place. A value of “false” indicates that the person exists externally to the specified place.

The subscribed_to_newsletter attribute specifies whether or not the person subscribed to the place's newsletter.

The subscribed_to_calender_events attribute specifies whether or not the person subscribed to the calendar events in the specified place.

The using_accessible_ui attribute specifies whether or not the person is using an accessibility user interface in the specified place.

The email_client attribute specifies which email client the person uses.

### Person Node Named Elements

The person node supports the following named elements:

<dn>

<username>

<first_name>

<last_name>

<password>

<phone_number>

<offline_password>

<description>

<email>

<theme>

The <dn> element is required for all supported place actions (create, remove, etc.) if operating on an external user. It is used by the person node to specify the external name of the person being serviced. This name refers to a person in a directory external to QuickPlace. This element is not specified when operating on a person that is local to the specified place

The <username> element is used by the person node to specify the person that is associated with the operation being performed. The value specified by this element represents a local user of the specified place. A local user is one that exists purely in the place and not in an external entity such as a directory. To specify an external user then the <dn> element described above is used.

The <password> element requires that the person attribute local=“true” be specified. The <password> element is used by the person node to specify the password of the person that is associated with the operation being performed. The value specified by this element represents the password of a local user of the specified place. This password will be required when the specified user authenticates with the place. This element is not applicable when the <dn> element is specified.

The <offline_password> element is used by the person node to specify the offline password of the person that is associated with the operation being performed. This password is used when the person authenticates with the place in offline mode. The value specified by this element can be used with either a local person or an external person.

The <theme> element is used by the person node to specify the name of the theme, or skin, associated with the operation being performed. The value specified by this element can be used with either a local person or an external person.

### Person Node Actions

Person node 115 supports the following actions:

add

remove

update

rename

The add action adds a person to the specified place. The person may exist locally to the place or may exist externally to the place in an external directory depending upon which attribute you specify for the person (see above). When adding an external person to a place, the external directory is not consulted for existence or name correctness. You can specify any supported attributes or elements of the person when the add action is performed since the specified person is updated immediately following this add operation.

The add action is performed to initially add a person to the specified place but it does not give that person any rights to access elements of the place. That action is performed by the <member> node. Table 21 illustrates an example of the add action.

TABLE 21
EXAMPLE PERSON NODE ADD ACTION

```
<service>
      <servers>
            <server>
                  <name>QPServer/ACME</name>
                  <hostname>qp.acme.com</hostname>
                  <port>80</port>
                  <places>
                        <place>
                              <name>ACME_Team</name>
                              <members>
                                    <person local=“true”
                                    action=“add”>
                                          <username>Jane
                                          Doe</username>
                                          <password>BigSecret
                                          </password>
                                          <first_name>Jane
                                          </first_name>
                                          <last_name>Doe
                                          </last_name>
                              </person>
                              <person action=“add”>
                                    <dn>cn=Charles Brown, ou=
                                    Sales, o=ACME </dn>
                              </person>
                              </members>
                        </place>
                  </places>
            </server>
      </servers>
</service>
```

The remove action removes a person from the specified place. The person may exist locally to the place or may exist externally to the place in an external directory depending upon which attribute you specify for the person (see above). Removing a local person removes that person from the specified place. Removing an external person removes that person the place but the external directory.

When a person is removed from a place, his membership to all rooms in the place is also removed.

The update action updates a person in the specified place. When this action is called, the specified person is updated using the attributes and values specified. Any supported attributes or elements of the person may be specified when the update action is performed. No updates are performed in the external directory if the person being updated is not local.

The rename action renames a person in the specified place. When this action is called, the specified person name is updated to the value specified. All other attributes of the person remain the same after the rename process. The person information in the external directory is not updated by this action. That must be done in a separate process outside of this script.

### Group Object 117

Group (external) node 117 represents a group on the QuickPlace server 101 in the QuickPlace service 100. All actions performed on a group are executed from within the place node hierarchy. Group operations are performed on groups that have identities in external directories. (Local groups 118 are groups that exist purely in the place.) Group 117 supports the following actions:

add

remove

update

rename

### Member Object 104

Member node 104 (inside room managers, readers and authors) represents a member of one or more rooms 113 in a specified place 114 on QuickPlace server 119 in QuickPlace service 100. All actions performed on a member 104 are executed from within the <room> node hierarchy 113. The member node 104 is primarily used to define, modify, or remove membership access to one or more rooms in the place 114. When performing actions on a member, a person 115, 116 or group 117, 118 that represents the member must have been previously defined in the script. Operations on a member node 104 are performed using an idref link to the person or group nodes previously defined in the script. An idref link relationship is illustrated in Table 22. Member 104 supports add, remove, and rename actions.

TABLE 22
IDREF LINK RELATIONSHIP ILLUSTRATION

```
<members>
      <person local=“true” id=“person1”>
            <username>jdoe</username>
      </person>
      <person id=“person2”>
            <dn>cn=Charles Brown,ou=Sales,o=ACME</dn>
      </person>
</members>
<rooms>
      <room>
            <name>Main.nsf</name>
                  <access>
                        <managers>
                              <member action=“add”>
                                    <link idref=“person1”/>
                              </member>
                        </managers>
                        <authors>
                              <member action=“remove”>
                                    <link idref=“person2”/>
                              </member>
                        </authors>
                  </access>
      </room>
</rooms>
```

The <person> node is defined first with a corresponding link ID value. That ID value if referenced through the <link idref> element to determine which <person> the <member> node should operate on.

The major distinction between a <person> or <group> and a <member> is that a <person> or <group> represents an entity that the place has information about. A <member> represents a <person> or <group> node's access or membership to a particular room.

### Alternative Embodiments

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. Method for hierarchically invoking reentrant methods on objects, comprising:
associating with each object an action attribute representing an API to be invoked;
processing said object to return an updated form of said object, said processing selectively including an action executed on said object;
for said actions executed on said object, creating a child node with action status representing whether said action was successful; and
on action success, removing said action attribute from said updated form.

2. The method of claim 1, said objects being API capable XML objects.

3. Method for hierarchically invoking reentrant methods on XML objects in a document, comprising:
traversing an XML input tree in sequential order as said objects appear in said document;
upon traversing in said input tree a target object with an action attribute, adding an action result object to said tree as a child object to said target object;
if an error is encountered in processing said action attribute in a target object during traversal, retaining said action attribute in said target object and processing a next sibling object in said sequential order without processing any children objects of said target object; and
if an action attribute in a target object is successfully processed during said traversal, removing said action attribute from said target object and processing a next object in said sequential order.

4. The method of claim 3, further comprising:
generating an XML resultant tree comprising said input XML tree with action result child objects added to each action object and action attributes removed from said action objects successfully processed.

5. The method of claim 4, further comprising:
correcting target objects having result action objects indicating error an action attributes to produce a corrected XML resultant tree;
processing said corrected XML resultant tree as a new XML input tree.

6. The method of claim 4, said objects comprising an object model including service objects, server objects, place objects, room objects, folder objects and document objects.

7. The method of claim 4, further comprising:
generating to said XML resultant tree new script resulting from processing selective action attributes; and
responsive to said XML resultant tree including an error action result child object or said new script, processing said XML resultant tree as a new input tree to generate a reentrant XML resultant tree.

8. System for hierarchically invoking reentrant methods on XML objects, comprising:
a first store for storing said XML objects as an input tree;
a second store for storing a resultant tree;
a processor for processing said input tree to generate said resultant tree;
action attribute indicia representing an API to be invoked associated with at least one said object;
said processor executing a depth first search through said input tree for generating said resultant tree selectively including action status child nodes for XML objects having an action attribute and new script generated from processing selective action attributes;
while generating said resultant tree, said processor removing said action attribute from XML action objects successfully processed; and
a reentrant processing path through said processor for processing said resultant tree as a new input tree responsive to said resultant tree including said new script or failure status child nodes.

9. A program storage device readable by a machine, tangibly embodying a program of instructions executable by a machine to perform method steps for hierarchically invoking reentrant methods on XML objects, said method comprising:
associating with each object an action attribute representing an API to be invoked;
processing said object to return an updated form of said object, said processing selectively including an action executed on said object;
for said actions executed on said object, creating a child node with action status representing whether said action was successful; and
on action success, removing said action attribute from said updated form.

10. A program storage device readable by a machine, tangibly embodying a program of instructions executable by a machine to perform method steps for hierarchically invoking reentrant methods on XML objects, said method comprising:
traversing an XML input tree in sequential order as said objects appear in said document;
upon traversing in said input tree a target object with an action attribute, adding an action result object to said tree as a child object to said target object;
if an error is encountered in processing said action attribute in a target object during traversal, retaining said action attribute in said target object and processing a next sibling object in said sequential order without processing any children objects of said target object; and
if an action attribute in a target object is successfully processed during said traversal, removing said action attribute from said target object and processing a next object in said sequential order.

11. The program storage device of claim 10, said method further comprising:
generating an XML resultant tree comprising said input XML tree with action result child objects added to each action object and action attributes removed from said action objects successfully processed.

12. The program storage device of claim 11, said method further comprising:
correcting target objects having result action objects indicating error an action attributes to produce a corrected XML resultant tree;
processing said corrected XML resultant tree as a new XML input tree.

13. The program storage device of claim 11, said objects comprising an object model including service objects, server objects, place objects, room objects, folder objects and document objects.

14. A computer program product for hierarchically invoking reentrant methods on XML objects according to the method comprising:
associating with each object an action attribute representing an API to be invoked;
processing said object to return an updated form of said object, said processing selectively including an action executed on said object;
for said actions executed on said object, creating a child node with action status representing whether said action was successful; and
on action success, removing said action attribute from said updated form.
